(19) United States
(12) Patent Application Publication
(10) Pub. No.: US 2006/0203875 A1
(43) Pub. Date: Sep. 14, 2006

(54) Optical module comprising an image sensor and a lens unit that is supported on the sensitive surface of the image sensor

(76) Inventors: Henryk Frenzel, Regensburg (DE); Harald Schmidt, Regensburg (DE); Stephan Voltz, Happurg (DE)

Correspondence Address: LERNER GREENBERG STEMER LLP, P O BOX 2480, HOLLYWOOD, FL, 33022-2480, US

(21) Appl. No.: 10/573,544

(22) PCT Filed: Sep. 7, 2004
(86) PCT No.: PCT/EP04/52060

§ 371 Date: Mar. 27, 2006

(30) Foreign Application Priority Data
Sep. 26, 2003 (DE) 10344762.8

(51) Int. Cl. H01S 3/08

(52) U.S. Cl. 372/101

(57) ABSTRACT

An optical module has a lens holder into which a lens array formed of three lenses and a diaphragm, for example, is inserted. The lenses, and optionally the diaphragm, are clearly oriented by way of the geometrical shape thereof such that no further optical adjustment is required while the lens array is disposed in a supported manner directly on the sensitive surface of the semiconductor element. A camera module can be designed which dispenses with the need to mechanically adjust the focus in any manner by supporting especially the lens holder or the lens or the peripheral area thereof directly on the chip surface. The optical module is particularly suitable for applications in the interior or exterior zone of a motor vehicle.

The invention relates to an optical module with a circuit carrier, a semiconductor element arranged on the circuit carrier and a lens unit for projecting electromagnetic radiation onto the semiconductor element.

The invention further relates to an optical system with an optical module embodied in this way.

Generic optical modules and systems are used especially in automotive technology.

In such cases operation can be with electromagnetic radiation from different frequency ranges, in which case cumulatively to the visible light, with which applications in the exterior area of a motor vehicle typically operate, such as LDW (Lane Departure Warning), BSD (Blind Spot Detection), or (Rear View Cameras), the infrared light which is invisible to the human eye is preferred for applications in the interior of the motor vehicle such as OOP (Out of Position Detection) or for additional outside illumination of a night vision system.

High demands are imposed on applications in the interior and exterior area of a vehicle as a result of external influences such as temperature, moisture, contamination and vibration. The typical lifetime for systems in the motor vehicle is around 10 to 15 years, with only extremely low failure rates being tolerated, so that the components of an optical system of the type mentioned at the start may only exhibit very slow ageing.

Since in many cases the space for installing optical modules or optical systems is very restricted, additional difficulties arise in implementing the optical systems. It is thus extremely difficult using conventional means to construct a hermetically sealed reliable unit consisting of a camera chip (currently CCD or CMOS sensors) and optics.

To achieve sufficiently sharp focus for a camera system, consisting of an image sensor (currently CCD or CMOS) and a lens system, the sensor and optics components must be matched geometrically very precisely to one another. The tolerance range for the distance from the camera chip to the optics in the z-axis usually lies in the range of a few hundredths of a millimeter to enable an optimally sharp image to be achieved for a specific depth of field. This is particularly a problem for so-called fixed-focus systems, since this tolerance which is small in any event may be exceeded during manufacturing. An additional consequence of an offset of camera chip to optics in the x- or y-axis is also that under some circumstances the optical system “squints”, i.e. the image is truncated on one edge (horizontal or vertical), since the offset means that pixels are no longer present here and would have to be provided as a precaution.

A further problem is presented by “tilt”, i.e. a misalignment of the camera chip around the x- or y-axis, resulting in the image exhibiting an out-of-focus gradient in the horizontal or vertical direction. In addition a “rotation” can also be produced, i.e. a rotation around the z-axis of camera chip to optics.

Almost all camera systems currently on the market which are supplied with a fixed focus setting need an additional compensation step during manufacturing, in which the distance from camera chip to optics along the z-axis is set and is fixed at this value. This is done for example using a thread and a corresponding adjustment screw or a glue connection. A compensation step can also be necessary for the x-y offset or, if this is not done, a correspondingly larger sensor can be provided which provides more pixels to allow for the tolerances. Software which processes or calibrates out the rotation is also known. Since otherwise sharp image information is present, the pixels only need to be reassigned in a type of “calibration” process. However there can no longer be any information at the edges or corners since these are truncated. Finally, a purely mechanical reduction of “tilt” and “rotation” between chip and optics can as a rule only be achieved with usual systems by high-precision manufacturing and assembly or by calibrating the components.

However cameras for specific low-cost applications such as automotive, industry, digital camera, mobiles, toys etc. should be manufactured from the standpoint of cost and of quality assurance aspects where possible without adjustment procedures between optics and camera chip, that is without making adjustments to the focus on the optical surface of the CMOS or CCD sensor. This basically conflicts with the stated requirements.

One possibility for developing a focus-free system is to reduce the sums of the possible tolerances and elements, so that the module or system functions as a result of the design without adjustment in at least one specific distance and temperature range. Where the invention is used for example within the framework of an occupant protection system of a motor vehicle, to which the present invention is however not restricted, sharper images at distances of for example 15 cm to 130 cm as well as at temperatures of for example −40° C. to +105° C. should be able to be guaranteed. The fewer elements are included in the tolerance chain, the easier this is to implement. A large element in the tolerance chain is taken up by the circuit carrier for the camera chip (currently CCD or CMOS for example). Thus, especially with unhoused chips, an attempt is made, for example by using very thin, so-called flexible circuit carriers, to include only a very small thickness tolerance. With housed semiconductor elements the soldered or glued connections or such like necessary between the chip and the circuit carrier in particular constitute a large element in the tolerance chain.

Using only one lens avoids additional optical tolerances being caused by a complicated lens construction. The lens holder, which is preferably made of plastic, can itself be connected to the lens arrangement in different ways so that an exact optical alignment of the lens arrangement and of the semiconductor element in relation to the lens holder or the lens arrangement respectively can always be ensured.

However with systems which largely feature a classical layout consisting of lens and camera chip, with the camera chip or the semiconductor element being accommodated in a housing or also unhoused as a so-called flip-chip or bonded onto a suitable circuit carrier, it is difficult to get around the given overall problems and simultaneously meet the given quality requirements. With housed semiconductor chips it is true to say that only particular measures need be taken to protect the front of the package from outside light radiation or other environmental influences, since the chip package offers sufficient protection from behind, e.g. for the Silicon which lets through IR radiation. The lens itself must however be adjusted to the camera chip and feature a defined focusing. This is done at present using tolerance-prone adjustment options through screwing, gluing or such like, by means of which the lens is fixed relative to the camera chip on the circuit carrier.

The object of the invention is to make available an optical module and an optical system with a semiconductor element arranged on a circuit carrier, in which the tolerances of the different components, especially between last lens surface and the sensor surface, such as glued connections, lens holder tolerance, thickness tolerance of the chips or such like, are practically eliminated, so that with simple and low-cost assembly a reliable optical quality can be provided without adjustment and especially without focusing effort and can be maintained over the lifetime of the module or system.

This object is achieved with the features of the independent claims. Advantageous embodiments of the invention, which can be used individually or in combination with each other, are specified in the dependent claims.

The invention builds on the generic optical module in that the lens unit is arranged supported directly on the sensitive surface of the semiconductor element. In this way the range of tolerances which is available for the focusing can be kept as small as possible so that this only still comprises manufacturing tolerances of the lens unit itself with the thickness tolerance of the necessary circuit carrier and any possible glued connections needed or such like being advantageously completely eliminated by the inventive layout.

In accordance with the invention the lens unit preferably features a lens holder which is arranged supported on the sensitive surface of the semiconductor element, with preferably a frame-type area or supports or such like being embodied on the lens holder or at least on sections of it, on which the semiconductor element rests with its optical surface. The fact that the chip rests directly on a for example frame-shaped area of the lens holder allows on the one hand the distance and thereby the focus range to be advantageously kept within the required dimensions, on the other hand it reduces the tilting of the components in relation to each other to a minimum.

In a preferred embodiment of the invention the lens unit features a support lens which can be disposed in a supported manner on the sensitive surface of the semiconductor element. This is preferably done by a design of the support lens being selected which features an essentially flat surface on the side facing away from the chip on which the camera chip rests directly.

To avoid the system being adversely affected as a result of contamination particles caused by wear or other problems between the flat surface of the support lens and be sensitive area of the semiconductor element, an optical gel is preferably disposed between these two surfaces.

As an alternative or in addition to a support lens with a flat surface, a support lens can be embodied such that the necessary distance to the camera sensor is implemented by a frame or supports or such like which are part of the lens. This can be easily implemented when plastic injection molded lenses are used, since here, in addition to the optically effective surface of the lens, regardless of whether this is embodied flat or classically concave, the edge area can be of almost any design. If the camera chip is not fabricated in a standard housing but for example in flip chip technology, this support can be obtained relatively simply since the chip surface is not covered here and can simultaneously serve as a reference.

In a further embodiment of the optical module in accordance with the present invention there is provision for the semiconductor element to be arranged on the side of the circuit carrier facing away from the lens unit and for the circuit carrier to feature an opening through which the electromagnetic radiation is projected from the lens arrangement onto the semiconductor element. The optical module is thus constructed in the sequence lens arrangement/circuit carrier or flexible circuit board/semiconductor element respectively. Even if embodiments are conceivable in which the sequence of circuit carrier and semiconductor element is reversed, it has proved particularly advantageous to provide the circuit carrier with an opening and thus allow the first sequence given above.

Especially preferably an embodiment of the frame-shaped area of the lens holder or the lens is then such that it firstly: is at least as large as the optically effective surface of the camera chip; and secondly: is only slightly smaller than the window in the substrate (e.g. flexible circuit board), on which the camera chip is mounted. With this type of embodiment a type of self centering can advantageously occur which guarantees the exact positioning of the chip in relation to the optics as regards the x- and y-axis and also reduces the “tilt” to a minimum.

In accordance with increasing miniaturization requirements the semiconductor element is preferably arranged unhoused on the circuit carrier as what is known as a flip chip, since the flip chip needs up to 40% less and thus significantly less circuit carrier surface when compared to a housed chip. In addition the desired lower position tolerance between the sensor chip and the circuit carrier in all three spatial directions can be achieved more easily by using flip chip technology. The “contact peaks” located on the semiconductor connection surfaces, such as solder balls, stud bumps etc., are connected to the circuit carrier or to the substrate by soldering, gluing or bonding. To obtain a reliable optical module in respect of environmental requirements such as temperature, humidity and mechanical shock, the practice of underfilling the semiconductor component with an underfiller is known. So that the underfiller flows into the gap between semiconductor element and circuit carrier and underfills the chip well it possesses a comparatively low viscosity and good flow characteristics. This in its turn has the disadvantage that, because of the space restrictions, the sensitive surface of the semiconductor element can be wetted in the edge areas and the corners so that the said areas are frequently no longer completely operable. In accordance with the invention the frame-shaped area of the lens holder or of the support lens is advantageously embodied enclosed so that the frame thus embodied, serving primarily a support function, also functions as a barrier against the flow of the underfill material, which advantageously prevents the underfill material which is introduced between chip and the substrate (for example a flexible circuit board) from wetting the optically effective surface of the semiconductor element.

In accordance with the invention the lens unit or the lens holder is preferably connected to the circuit carrier away from the opening embodied in the circuit carrier, especially glued, laser welded, screwed and/or in other such ways, so that a connection between circuit board and lens unit or lens holder is made available which fixes the inventive support of the lens unit on the semiconductor element and practically excludes any additional uncertainty as regards the optical quality of the module.

The invention further comprises an optical system with an optical module of the type stated above. In this way the advantages of the optical module can also be brought to bear within the framework of an overall system.

The invention is based on the knowledge that by supporting especially the lens holder lens or the lens edge area directly on the surface of the chip a camera module can be constructed in which it is possible to dispense with any mechanical focus setting. Thus the module can be manufactured fully automatically, which with large volumes has the advantage of lowering manufacturing and assembly costs. Furthermore the optical module can be developed without moving parts such as threads or fixing screws, which results in a higher reliability. The smaller tolerances of the design, including in the x- and y-axis, mean that the chip surface does not have to be unnecessarily large, which makes the camera chip cheaper. Such a module can be a very compact design which has the advantage of allowing the camera module to also be used in applications where space is restricted.

The invention can be employed especially usefully in the implementation of video systems, if necessary in combination with radar systems, ultrasound systems or such like in the automotive area.

The invention is now explained with reference to the accompanying drawings by preferred embodiments.

The figures show schematic diagrams of:

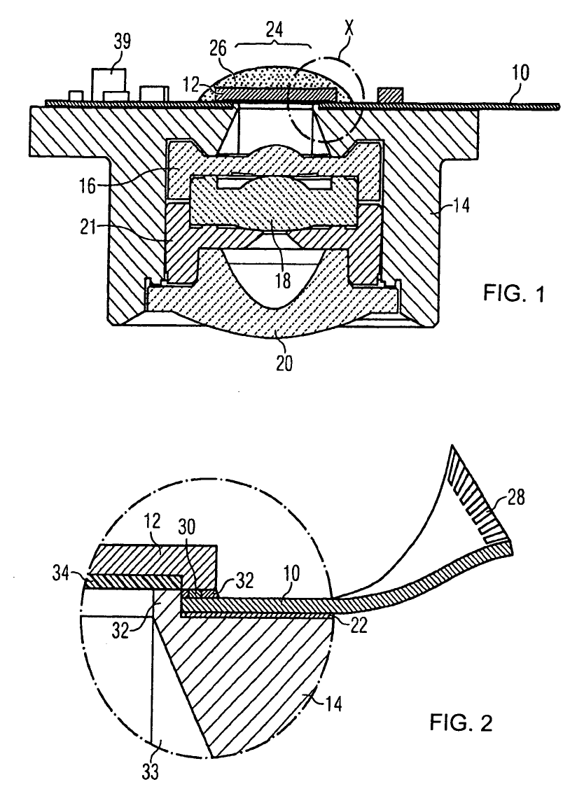

FIG. 1 the cross-sectional view of a first exemplary embodiment of the inventive optical module with a lens holder, on which a frame for supporting the module on the semiconductor element is embodied;

FIG. 2 an enlarged section X of the optical module shown in FIG. 1;

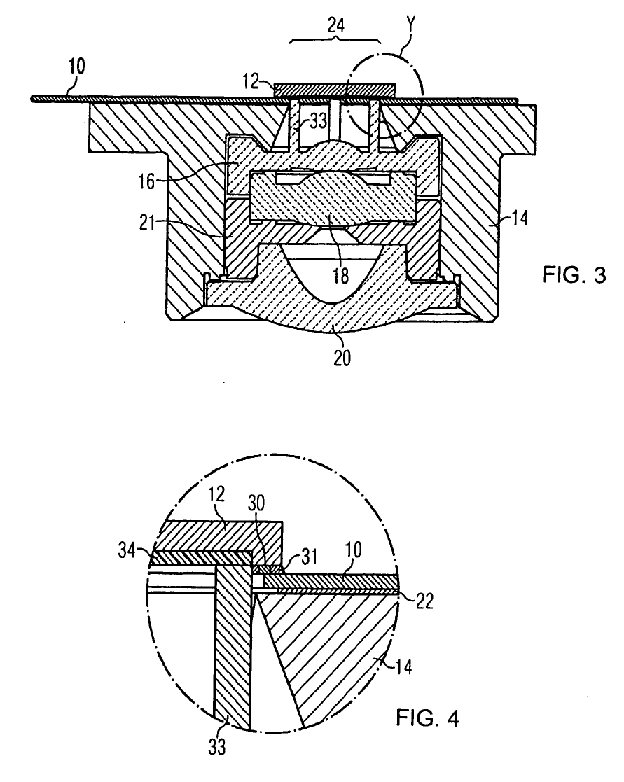

FIG. 3 the cross-sectional view of a second exemplary embodiment of the inventive optical module with a support lens on which supports for supporting the module on the semiconductor element are embodied;

FIG. 4 an enlarged section Y of the optical module shown in FIG. 3;

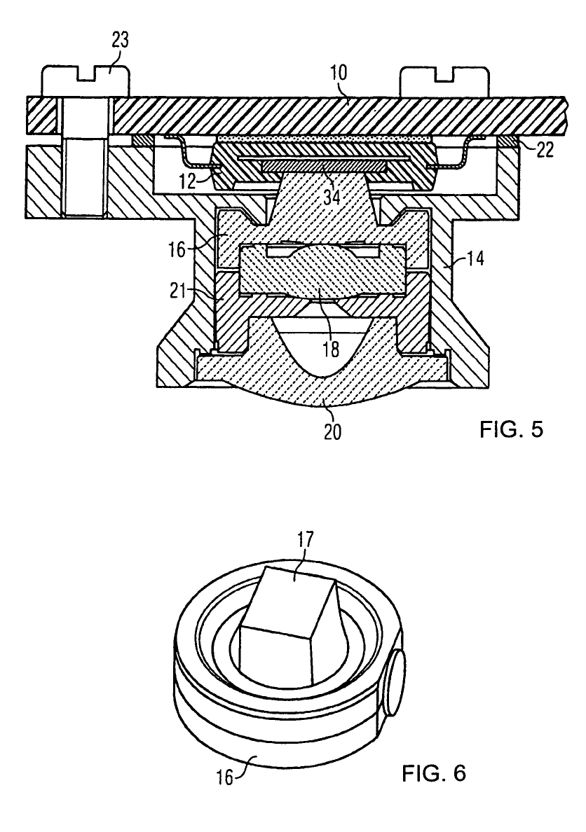

FIG. 5 the cross-sectional view of a third exemplary embodiment of the inventive optical module with a support lens on which a flat surface for supporting the module on the semiconductor element is embodied; and

FIG. 6 the support lens shown in FIG. 5 in an enlarged perspective view.

In the description of the preferred embodiment of the present invention below the same reference symbols refer to the same or comparable components.

FIG. 1 shows the cross-sectional view of a first exemplary embodiment of the inventive optical module with the lens unit 14; 16, 18, 20; 21, which comprises a lens holder 14, on which, to support it on the semiconductor element 12, a frame 32 is embodied in at least sections of the holder (cf. also FIG. 2). The semiconductor element 12 can be designed in accordance with current technology, e.g. as CMOS or CCD. The connection between the semiconductor element 12 and the circuit carrier 10, on which further electronic components 39 can be arranged, is preferably made using flip chip technology, by establishing a solder connection via solder bumps 30. Since with flip chip technology the sensitive active surface 34 is facing the substrate 10, a corresponding opening 24 must be present in the circuit carrier 10 or substrate so that electromagnetic radiation can reach the surface 34 of the semiconductor element 12 sensitive to electromagnetic radiation. In addition to or as well as the solder connection 30, a glued connection (not shown) can also be provided. In any event it is worthwhile subsequently reinforcing the connection with an underfill material 31. Especially in these cases it is preferable in accordance with the invention to embody the frame 32 enclosed so that this frame 32 simultaneously acts as a flow barrier and can prevent underfill material 31 wetting the optically effective surface 34 of the semiconductor element 12. To protect the expensive semiconductor element 12 against environmental influences its cover is provided with a Globtop 26.

FIG. 2 shows an enlarged section X of the optical module shown in FIG. 1. It is particularly evident that the circuit carrier 10 is embodied as a thin flex-PCB and is glued to the lens holder 14, for example using a thin double-sided adhesive strip 22. On the opposite end of the flex-foil 10 the foil is provided with solder pads 28 so that preferably without the effort of a further electrical connection, contact can be established between the optical module and a rigid circuit board (not shown), for example through hot bar soldering using the solder pads 28. As an alternative to this, depending on the design and/or appropriateness to the circuit carrier 10, a corresponding electrical connection can also be implemented using a ribbon cable (not shown). To allow ventilation of the optical module, particularly with wide variations in temperature, a slot (not shown) for ventilation can be provided, for example in the adhesive strip 22. Likewise it is possible to arrange a glued pressure equalization element on an opening (not shown).

In the lens holder 14 in accordance with FIG. 1 a lens arrangement with a number of lenses 16, 18, 20 and if necessary a diaphragm 21 in form of a package is preferably used. The optical quality can be improved by a lens with a number of lenses, which is also possible within the framework of the present invention, especially since it is possible to work with fine tolerances here. In this connection it is also especially advantageous for the lenses 16, 18, 20 and also the diaphragm 21 to be formed so that they assume a defined position relative to one another within the lens holder 14. Furthermore at least one of the lenses 20 is designed so that it interacts with the lens holder 14 and thus assumes a defined position in relation to the lens holder 14 and in the final analysis, as a result of the lens holder 14 being supported on the semiconductor element 12, it assumes a defined position in relation to the latter 12. In this way all lenses 16, 18, 20 and where necessary diaphragms 21 are adjusted in relation to a semiconductor element 12. This adjustment is not influenced by further measures since the lens holder 14 is supported directly on the semiconductor element 12.

FIG. 3 shows the cross-sectional view of a second exemplary embodiment of the inventive optical module with a support lens 16 on which supports 33 to support the module on the semiconductor element 12 are embodied. Likewise the support lens 16 can be embodied so that the necessary spacing to the camera sensor 12 is implemented at least in sections by a frame (not shown) or such like.

FIG. 4 shows an enlarged section Y of the optical module in accordance with FIG. 3. Supports 33 or frames are part the lens 16 and can be easily implemented especially when plastic molded lenses are used, since here in addition to the optically effective surface of the lens the edge area can be designed in almost any form.

FIG. 5 shows the cross-sectional view of a third exemplary embodiment of the inventive optical module with a support lens 16 on which a flat surface 17 to support the module on a semiconductor element 12 is embodied. Unlike the previous drawings, the diagram in FIG. 5 clearly shows that the semiconductor element 12 can of course be a housed chip 12 and the circuit carrier can be a rigid PCB 10. The connection between lens unit and circuit carrier can initially be fixed by an adhesive strip 22 and finally fixed by means of screws 23.

FIG. 6 finally shows the support lens 16 in accordance with FIG. 5 with its flat support surface 17 in an enlarged perspective diagram.

The present invention, by supporting the lens holder or the lens or the lens edge area directly on the chip surface, allows the construction of a camera module in which any kind of mechanical focus setting can be dispensed with. Thus the module can be manufactured fully automatically, which with large volumes has the advantage that manufacturing and assembly costs are reduced. Furthermore the optical module can be developed without moving parts such as threads or fixing screws, which results in a higher reliability. The smaller tolerances of the design, including in the x- and y-axis, mean that the chip surface does not have to be unnecessarily large, which makes the camera chip cheaper. Such a module can be a very compact design which has the advantage of allowing the camera module to also be used in applications where space is restricted. Furthermore the layout described offers the opportunity of designing a hermetically sealed module which is protected against environmental influences such as moisture or dust. In the case of a flip chip construction the frame which is used for support can simultaneously be used as a protective barrier for the underfill material, i.e. prevent the material which is introduced between the chip and the substrate (e.g. flexible circuit board) from wetting the optically effective surface of the chip.

The features of the invention disclosed in this description, in the drawings and in the claims can be of importance both individually and in any combination for implementing the invention. They are especially suitable for applications in the interior and/or exterior area of a motor vehicle.

1-12. (canceled)

13. An optical module, comprising:
a circuit carrier;
a semiconductor element disposed on said circuit carrier, said semiconductor element having an optically sensitive surface; and
a lens unit for projecting electromagnetic radiation onto said semiconductor element;
said lens unit being supported directly on said sensitive surface of said semiconductor element.

14. The optical module according to claim 13, wherein said lens unit includes a lens holder supported on said sensitive surface of said semiconductor element.

15. The optical module according to claim 13, which further comprises a frame-shaped area formed on said lens holder, wherein said semiconductor element rests on said frame-shaped area with said optically sensitive surface.

16. The optical module according to claim 13, which further comprises a frame-type support formed on said lens holder, wherein said semiconductor element rests on said support with said optically sensitive surface.

17. The optical module according to claim 13, wherein said lens unit includes a support lens disposed on said sensitive surface of said semiconductor element.

18. The optical module according to claim 17, wherein said support lens is formed with a flat surface resting on said sensitive surface of said semiconductor element.

19. The optical module according to claim 18, which comprises an amount of optical gel between the flat surface of said support lens and said sensitive surface of said semiconductor element.

20. The optical module according to claim 17, which further comprises a frame-type support formed on said support lens at least in sections thereof, and wherein said sensitive area of said semiconductor element rests on said support.

21. The optical module according to claim 13, wherein:
said lens unit is disposed on one side of said circuit carrier and said semiconductor element is disposed on an opposite side thereof; and
said circuit carrier is formed with an opening allowing electromagnetic radiation to be projected by a lens assembly of said lens unit onto said semiconductor element.

22. The optical module according to claim 20, wherein said frame-type support of said support lens is:
at least as large as said sensitive surface of said semiconductor element; and
slightly smaller than an opening formed in said circuit carrier through which electromagnetic radiation is projected onto said semiconductor element.

23. The optical module according to claim 15, wherein said frame-shaped area of said lens holder is:
at least as large as said sensitive surface of said semiconductor element; and
slightly smaller than an opening formed in said circuit carrier through which electromagnetic radiation is projected onto said semiconductor element.

24. The optical module according to claim 16, wherein:
said semiconductor element is flip-chip mounted on said circuit carrier;
said lens holder or a support lens is formed with a closed frame formed to function as a flow barrier against an underfill material introduced between said semiconductor element and said circuit carrier during a mounting operation of said semiconductor element on said circuit carrier.

25. The optical module according to claim 16, wherein said lens unit or a lens holder are connected to said circuit carrier away from an opening formed in said circuit carrier.

26. The optical module according to claim 25, wherein said lens unit or said lens holder are connected to said circuit carrier by gluing, laser-welding, and/or screwing.

27. An optical system, comprising an optical module according to claim 13.
